(19) United States
(12) Patent Application Publication
(10) Pub. No.: US 2018/0091580 A1
(43) Pub. Date: Mar. 29, 2018

(54) METHOD AND APPARATUS FOR CONTROLLING DEVICE

(71) Applicant: Beijing Xiaomi Mobile Software Co., Ltd., Beijing (CN)

(72) Inventors: Huayijun LIU, Beijing (CN); Ke WU, Beijing (CN); Tao CHEN, Beijing (CN)

(73) Assignee: Beijing Xiaomi Mobile Software Co., Ltd.

(21) Appl. No.: 15/716,578

(22) Filed: Sep. 27, 2017

(30) Foreign Application Priority Data
Sep. 28, 2016 (CN) 201610861147.9

(51) Int. Cl. H04L 29/08; H04W 4/20; G06K 9/00

(52) U.S. Cl. CPC H04L 67/025; H04W 4/203; G06K 9/00335; G06K 9/00369; H04L 67/2819

(57) ABSTRACT

The present disclosure discloses a method and apparatus for controlling a device. The method includes: collecting biological characteristic information; acquiring a control operation corresponding to the biological characteristic information, different biological characteristic information corresponding to different control operations; and controlling the device to execute a preset function according to the acquired control operation.

### CROSS-REFERENCE TO RELATED APPLICATION

This application is based upon and claims priority to Chinese Patent Application No. CN201610861147.9, filed on Sep. 28, 2016, the entire contents of which are incorporated herein by reference.

### TECHNICAL FIELD

The present disclosure generally relates to smart control, and more particularly, to a method and an apparatus for controlling a device.

### BACKGROUND

With improvement of sciences and technologies, more and more smart home appliances are adopted in people's life, for example, a smart window, a smart lamp and a smart air conditioner.

In conventional technologies, when smart home appliances are used, a user is required to control the smart home appliances through a fixed button to execute a fixed function. For example, when a smart air conditioner is used, the user is required to turn on the smart air conditioner through a button 1, control a temperature through a button 2, control an air volume through a button 3, control setting a timing through a button 4 or the like.

Since a user is required to control smart home appliances through a fixed button to execute a corresponding function, complexity in controlling the smart home appliances in the abovementioned solution is higher. Particularly, when the smart home appliances have more functions, the user is required to find a desired button from multiple buttons, and then may control the smart home appliances accordingly. Therefore, the complexity of controlling the smart home appliance is even higher.

### SUMMARY

According to a first aspect of the present disclosure, there is provided a method for controlling a device, comprising: collecting biological characteristic information; acquiring a control operation corresponding to the biological characteristic information, different biological characteristic information corresponding to different control operations; and controlling the device to execute a preset function according to the acquired control operation.

According to a second aspect of the present disclosure, there is provided an apparatus for controlling a device, comprising: a processor; and a memory configured to store instructions executable by the processor, wherein the processor is configured to: collect biological characteristic information; acquire a control operation corresponding to the biological characteristic information, different biological characteristic information corresponding to different control operations; and control the device to execute a preset function according to the acquired control operation.

According to a third aspect of the present disclosure, there is provided a non-transitory computer-readable storage medium having stored therein instructions that, when executed by a processor, causes the processor to perform a method for controlling a device, the method comprising: collecting biological characteristic information; acquiring a control operation corresponding to the biological characteristic information, different biological characteristic information corresponding to different control operations; and controlling the device to execute a preset function according to the acquired control operation.

It should be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of an implementation environment for controlling a device according to an exemplary embodiment.

FIG. 2 is a flow chart of a method for controlling a device according to an exemplary embodiment.

FIG. 3 is a flow chart of a method for controlling a device according to another exemplary embodiment.

FIG. 4 is a schematic diagram of setting a relationship in a mobile terminal according to an exemplary embodiment.

FIG. 5 is a flow chart of a method for controlling a device according to another exemplary embodiment.

FIG. 6 is a flow chart of a method for controlling a device according to another exemplary embodiment.

FIG. 7 is a schematic diagram of setting a relationship in a mobile terminal according to an exemplary embodiment.

FIG. 8 is a block diagram of an apparatus for controlling a device according to an exemplary embodiment.

FIG. 9 is a block diagram of an apparatus for controlling a device according to another exemplary embodiment.

FIG. 10 is a block diagram of an apparatus for controlling a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

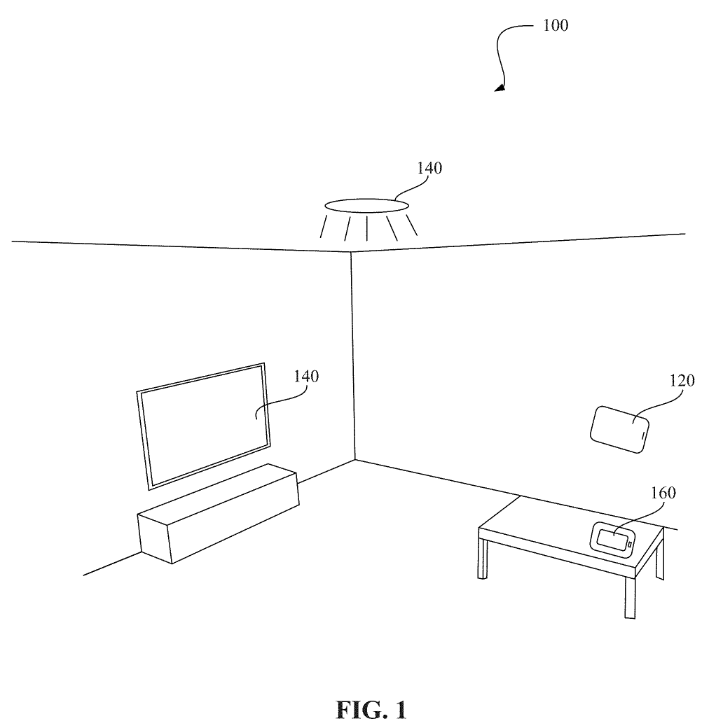

FIG. 1 is a schematic diagram of an implementation environment 100 for controlling a device according to an exemplary embodiment. As shown in FIG. 1, the implementation environment 100 may include a control terminal 120 and one or more smart home appliance 140.

The control terminal 120 may be configured to collect biological characteristic information. The biological characteristic may include, but is not limited to, a fingerprint, an iris, a vein, a retina, a pulse, skin, a voice, a face or the like.

In one embodiment, the control terminal 120 may be a smart mobile phone, a tablet computer, an electronic book reader, a control console on a wall or the like. For example, the control terminal 120 is a control panel arranged on a wall of a house.

In one embodiment, the control terminal 120 establishes a communication connection with the smart home appliance 140 in at least one manner of Bluetooth (BT), Wireless Fidelity (WIFI) and Near Field Communication (NFC) technologies.

The smart home appliance 140 may include at least one of a smart home appliance device, a smart window and a smart curtain. The smart home appliance device may be a smart lamp, a smart air conditioner, a router, a smart power strip, a smart television or the like. The smart home appliance 140 may execute a preset function under control of the control terminal 120.

In one embodiment, the implementation environment 100 further includes a mobile terminal 160.

The mobile terminal 160 may be configured to collect biological characteristic, and establishes a communication connection with the control terminal 120 and the smart home appliance 140, respectively, in at least one manner of BT, WIFI and NFC.

In one embodiment, the mobile terminal 160 is a smart mobile phone, a tablet computer, a smart television, an electronic book reader, a multimedia player, a laptop computer or the like.

In one embodiment, a relationship between biological characteristic information and control operations is preset in the mobile terminal 160. For example, after the mobile terminal 160 establishes a communication connection with the smart home appliance 140, an identifier of the smart home appliance 140 is acquired; after each piece of sample biological characteristic information is collected, a setting signal is received; the mobile terminal 160 determines the smart home appliance and the preset function according to the setting signal and the acquired identifier of the smart home appliance 140; and a corresponding control operation is set for each piece of sample biological characteristic information. Herein, the control operation includes an operation for controlling the smart home appliance to execute the preset function.

An examplary process that the control terminal 120 controls the smart home appliance 140 to execute the preset function includes that the following: the control terminal 120 sends an acquisition request to the mobile terminal 160 after collecting biological characteristic information, wherein the sample biological characteristic information includes the biological characteristic information; a relationship fed back by the mobile terminal 160 is received; and a control operation corresponding to the biological characteristic information is acquired according to the relationship, thereby controlling the smart home appliance 140 to execute the preset function.

In one embodiment, the control terminal 120 sends the collected biological characteristic information to the mobile terminal 160, and receives the control operation fed back by the mobile terminal 160, thereby controlling the smart home appliance 140 to execute the preset function, wherein the control operation is acquired according to the relationship and corresponds to the biological characteristic information.

In one embodiment, the relationship between the biological characteristic information and the control operations is pre-stored in the control terminal 120. The control operation corresponding to the biological characteristic information is acquired according to the relationship, thereby controlling the smart home appliance 140 to execute the preset function.

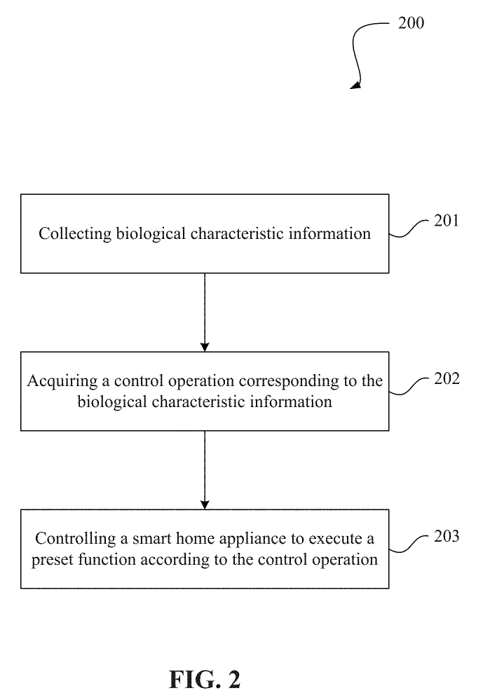

FIG. 2 is a flow chart of a method 200 for controlling a device according to an exemplary embodiment. As shown in FIG. 2, the method 200 is applied to the control terminal 120 shown in FIG. 1, and includes the following steps.

In Step 201, biological characteristic information is collected.

In Step 202, a control operation corresponding to the biological characteristic information is acquired. Herein, different biological characteristic information corresponds to different control operations.

In Step 203, a smart home appliance is controlled to execute a preset function according to the acquired control operation. Herein the smart home appliance includes at least one of a smart home appliance device, a smart window and a smart curtain.

According to the method 200 above, biological characteristic information is collected; a control operation corresponding to the biological characteristic information is acquired; and a smart home appliance is controlled to execute a preset function according to the control operation. Therefore, problems associated with conventional technologies can be solved. Such problems may include, for example, a relatively more tedious control process, and a relatively higher complexity in user's operations since the user is required to control the smart home appliance through a fixed button to execute a fixed function when using the smart home appliance. Accordingly, controlling a smart home appliance to execute a preset function according to a control operation corresponding to biological characteristic information of a user, can reduce complexity in control over the smart home appliance and simplify the control process .

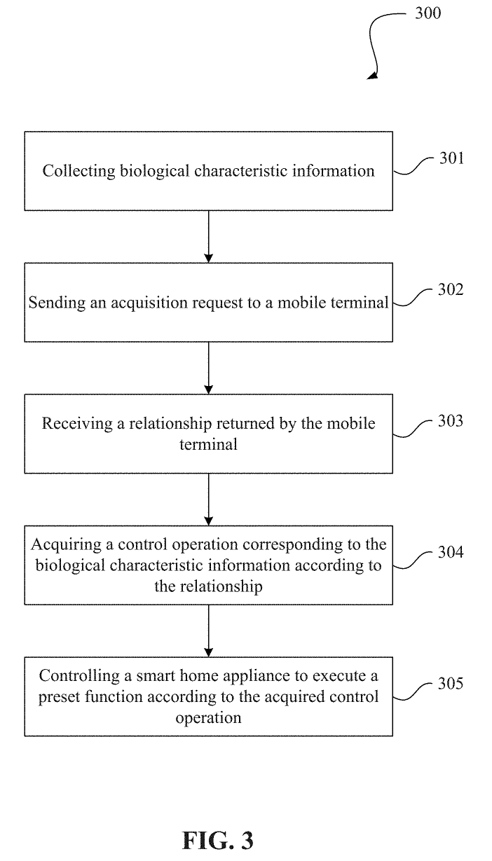

FIG. 3 is a flow chart of a method 300 for controlling a device according to another exemplary embodiment. As shown in FIG. 3, the method 300 is applied to the control terminal 120 shown in FIG. 1, and includes the following steps.

In Step 301, biological characteristic information is collected. The control terminal 120 collects the biological characteristic information through a biological characteristic collector. A biological characteristic may include: a fingerprint, an iris, a vein, a retina, a pulse, skin, a voice, a face or the like.

In one embodiment, different types of biological characteristic collectors are adopted for different biological characteristics. For example, when the biological characteristic is a fingerprint, the biological characteristic collector is a fingerprint identification sensor. When the biological characteristic is an iris, a face or skin, the biological characteristic collector is a camera. When the biological characteristic is a voice, the biological characteristic collector is a Microphone (MIC).

In Step 302, an acquisition request is sent to a mobile terminal. The control terminal 120 establishes a communication connection with the mobile terminal in at least one manner of BT, WIFI and NFC.

The control terminal 120 sends the acquisition request to the mobile terminal with which the connection is established in real time after collecting the biological characteristic information. The acquisition request is a request configured to acquire a relationship from the mobile terminal. The relationship includes: a relationship between biological characteristic and control operations.

In one embodiment, when the smart appliance is a smart window, the control operation includes: one of opening the smart window, closing the smart window, locking the smart window or regulating an opening angle of the smart window. When the smart appliance is a smart lamp, the control operation includes: one of turning on, turning off or regulating luminance. When the smart appliance is a smart curtain, the control operation includes: regulating an opening width or regulating an opening height. When the smart appliance is a smart air conditioner, the control operation includes: one of turning on, turning off, temperature regulation, air volume regulation or timing

The relationship between the biological characteristic information and the control operations is pre-stored in the mobile terminal. An exemplary process of pre-storing the relationship in the mobile terminal may include the following steps.

In step one: the mobile terminal collects at least one piece of sample biological characteristic information. The sample biological characteristic information includes the biological characteristic information. The mobile terminal collects the at least one piece of sample biological characteristic information through a biological characteristic collector in advance.

In one embodiment, the at least one piece of sample biological characteristic information includes: at least one piece of sample biological characteristic information of the same user, or, at least one piece of sample biological characteristic information of multiple users. For example, the mobile terminal collects fingerprint images of different fingers of the same user as sample fingerprint images. In another example, the mobile terminal acquires fingerprint images of different fingers of three users as sample fingerprint images.

In step two: the mobile terminal receives a setting signal, and sets a control operation corresponding to each piece of sample biological characteristic information according to the setting signal.

The mobile terminal receives the setting signal triggered by a user after collecting the at least one piece of sample biological characteristic information. The setting signal refers to a signal of setting a corresponding control operation for each piece of sample biological characteristic information. The mobile terminal sets the control operation corresponding to each piece of sample biological characteristic information according to the setting signal after receiving the setting signal.

For example, for fingerprint images of different fingers of the same user, corresponding control operations for executing preset functions of a smart window may be set for a combination of a fingerprint image of the left thumb, a fingerprint image of the index finger and a fingerprint image of the middle finger; corresponding control operations for executing preset functions of a smart lamp may be set for a combination of a fingerprint image of the left ring finger and a fingerprint image of the little finger; corresponding control operations for executing preset functions of a smart curtain may be set for a combination of a fingerprint image of the left thumb and a fingerprint image of the left index finger; and corresponding control operations for executing preset functions of a smart air conditioner may be set for a combination of a fingerprint image of the left middle finger and a fingerprint image of the left ring finger.

As an example, if the biological characteristic information is a fingerprint image and the smart home appliance is a smart window, a relationship between the biological characteristic information and the control operations is shown in the following Table 1.

TABLE 1

| Biological | |
|---|---|
| characteristic | |
| information | Control operation |
| Fingerprint image A | A smart window 1 executes an opening operation |
| Fingerprint image B | A smart window 2 and a smart window 3 execute an |
| | opening operation |
| Fingerprint image C | A smart window 4, a smart window 5 and a smart |
| | window 6 execute an opening operation |

From Table 1, it can be seen that the control operation corresponding to the fingerprint image A is that the smart window 1 executes an opening operation; the control operation corresponding to the fingerprint image B is that the smart window 2 and the smart window 3 execute an opening operation; and the control operation corresponding to the fingerprint image C is that the smart window 4, the smart window 5 and the smart window 6 execute an opening operation.

In step three: the mobile terminal establishes and stores a relationship between sample biological characteristic information and a corresponding control operation. After setting the corresponding control operation for each piece of sample biological characteristic information, the mobile terminal establishes the relationship between the sample biological characteristic information and the corresponding control operation, and stores the relationship between each piece of sample biological characteristic information and the control operation.

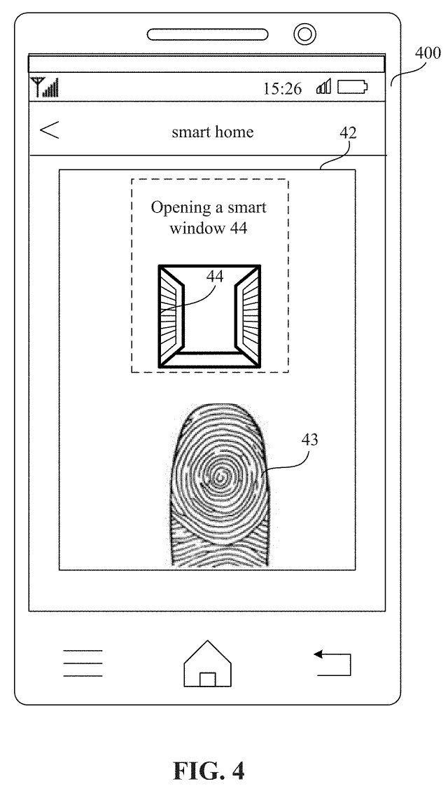

In an exemplary example, the sample biological characteristic information is sample fingerprint images. A schematic diagram illustrating pre-storage of the relationship in the mobile terminal is shown in FIG. 4. The mobile terminal 400 collects the sample fingerprint images through a display interface 42 of a third-party Application (APP) of the smart home appliance, and sets a corresponding control operation for each sample fingerprint image. For example, a control operation corresponding to the sample fingerprint image 43 includes that: a smart window 44 executes an opening operation.

In Step 303, a relationship returned by the mobile terminal is received.

The mobile terminal feeds back the pre-stored relationship to the control terminal after receiving the acquisition request. The control terminal receives the relationship fed back by the mobile terminal according to the acquisition request.

In Step 304, a control operation corresponding to the biological characteristic information according to the relationship is acquired.

After receiving the relationship, the control terminal acquires the control operation corresponding to the collected biological characteristic information according to the relationship, between the biological characteristic information and the control operations.

For example, referring to the relationship shown in Table 1, when the biological characteristic information collected by the control terminal is the fingerprint image B, the control operation corresponding to the fingerprint image B acquired by the control terminal according to the relationship fed back by the mobile terminal and is that: the smart window 2 and the smart window 3 execute an opening operation.

In Step 305, a smart home appliance is controlled to execute a preset function according to the acquired control operation.

The control terminal controls the smart home appliance to execute the preset function according to the control operation after acquiring the control operation corresponding to the collected biological characteristic information.

Herein, the smart home appliance includes at least one of a smart home appliance device, a smart window and a smart curtain. In one embodiment, the smart home appliance includes a smart window. The control terminal controls the smart window to be opened, closed and locked or regulates an opening angle of the smart window according to a control operation after acquiring the control operation.

For example, a user inputs a fingerprint image of his thumb into a control panel arranged on a wall of his home. The control panel sends an acquisition request to a mobile phone A of the user, which establishes a connection with the control panel in advance through WIFI, after collecting the fingerprint image of the thumb finger of the user. The mobile phone A feeds back to the control panel a pre-stored relationship between fingerprint images of the user and control operations. The control panel acquires a control operation corresponding to the fingerprint image of the thumb of the user according to the relationship fed back by the mobile phone A. In the present example, the acquired control operation is an operation of opening a window 2 and window 3 of a front balcony .The control panel opens the window 2 and window 3 of the front balcony according to the control operation.

In one embodiment, the smart home appliance includes a smart lamp The control terminal controls the smart lamp to be turned on or turned off or regulates illuminance according to a control operation after acquiring the control operation.

For example, the user inputs his own face information into the control panel arranged on the wall, the control panel sends an acquisition request to the mobile phone A, which establishes the connection with the control panel in advance through WIFI, after collecting the face information of the user. The mobile phone A feeds back to the control panel a pre-stored relationship between face information of the user and control operations. The control panel acquires a control operation corresponding to the face information of the user according to the relationship fed back by the mobile phone A. The acquired control operation is an operation to turn off a lamp A and lamp B in a living room. The control panel turns off the lamp A and the lamp B according to the acquired control operation.

In one embodiment, the smart home appliance includes a smart air conditioner. The control terminal controls the smart air conditioner to be turned on and turned off, regulates a temperature or an air volume or implements timing according to a control operation after acquiring the control operation.

For example, the user inputs his own voice information into the control panel arranged on the wall. The control panel sends the voice information to the mobile phone A, which establishes the connection with the control panel in advance through WIFI, after collecting the voice information of the user. The mobile phone A acquires a control operation corresponding to the voice information of the user according to a pre-stored relationship between voice information of the user and control operations that is fed back by the mobile phone A to the control panel. In the present example, the control operation is an operation of turning on the air conditioner in a room and regulating a temperature to 25° C. The control panel turns on the air condition in the room and regulates the temperature to 25° C. according to the received control operation.

In one embodiment, the smart home appliance includes a smart curtain. The control terminal controls the smart curtain to regulate an opening width or regulate an opening height according to a control operation after acquiring the control operation.

For example, the user inputs his own iris information into the control panel arranged on the wall. The control panel sends an acquisition request to the mobile phone A, which establishes the connection with the control panel in advance through WIFI, after collecting the iris information of the user. The mobile phone A feeds back to the control panel a pre-stored relationship between iris information of the user and a control operation. The control panel acquires the control operation corresponding to the iris information of the user according to the relationship fed back by the mobile phone A. In the present example, the control operation is an operation of opening the curtain in the room by a 2-meter width. The control panel opens the curtain in the room to be 2 meters wide according to the acquired control operation.

According to the method 300 above, the biological characteristic information is collected; the control operation corresponding to the biological characteristic information is acquired; and the smart home appliance is controlled to execute the preset function according to the control operation. Therefore, problems associated with the conventional technologies can be addressed. Such problems may include, for example a relatively more tedious control process and relatively higher complexity in user's operation since the user is required to control the smart home appliance to execute a fixed function through a fixed button when using the smart home appliance. Accordingly, controlling the smart home appliance to execute the preset function according to the control operation corresponding to the biological characteristic information of the user, can reduce complexity in control over the smart home appliance and simplify the control process.

In an exemplary example, a control terminal is located in the house of a user, and a relationship between fingerprint images of four fingers of the user and control operations is pre-stored in a mobile phone C of the user. For example, the control operation corresponding to a fingerprint image of the thumb is that: a smart window 11 and a smart window 12 in a front balcony execute an opening operation; the control operation corresponding to a fingerprint image of the index finger is that: a smart window 13 in a rear balcony executes an opening operation; the control operation corresponding to a fingerprint image of the middle finger is that: a smart window 14 and a smart window 15 in a large room execute an opening operation; and the control operation corresponding to a fingerprint image of the ring finger is that: a smart window 16 and a smart window 17 in a living room execute an opening operation. The control terminal establishes a connection with the mobile phone C through WIFI in the user's home at first. When the user is required to open a window in the large room, the user inputs a fingerprint image of the middle finger into the control terminal. The control terminal collects the fingerprint image of the middle finger of the user, and sends an acquisition request to the mobile phone C after collecting the fingerprint image of the middle finger. After the mobile phone C receives the acquisition request, the mobile phone C returns to the control terminal the relationship between the fingerprint images of the four fingers of the user and the control operations. The control terminal acquires the control operation (the smart window 14 and smart window 15 in the large room execute the opening operation) corresponding to the fingerprint image of the middle finger according to the received relationship. The control terminal opens the smart window 14 and smart window 15 in the large room according to the acquired control operation.

In some embodiments, more than one control terminal may be used. For example, one control terminal is arranged in each story in a two-story building.

In some embodiments, the relationship may be that a combination of at least two pieces of biological characteristic information corresponds to a control operation. The at least two pieces of biological characteristic information may be biological characteristic information of the same type, for example, a combination of a fingerprint image of the thumb and a fingerprint image of the index finger of the user. The at least two pieces of biological characteristic information may also be biological characteristic information of different types, for example, the face of the user and a fingerprint image of the user.

In some embodiments, before the control terminal collects the biological characteristic information, the user may pre-select a type of the smart home appliance to be controlled through the control terminal. And then the biological characteristic information is collected, the control operation corresponding to the biological characteristic information is acquired, and the smart home appliance is controlled to execute the preset function according to the control operation. In one embodiment, for different types of smart home appliances, the same biological characteristic information may correspond to different control operations. For example, when the user selects a smart window, the control operation corresponding to the fingerprint image of the index finger of the user is that: the smart window 1 and the smart window 2 execute an opening operation; and when the user selects a smart lamp, the control operation corresponding to the fingerprint image of the index finger of the user is that: the smart lamp A and the smart lamp B execute a turning-off operation.

In some embodiments, the control terminal may be divided into N regions wherein N is an integer number greater than one, and the relationship includes a relationship among region identifiers, biological characteristic information and control operations. For example, a control operation corresponding to a fingerprint image of the thumb of a user in a region 1 is that the smart window A executes an opening operation; and a control operation corresponding to a fingerprint image of the thumb of a user in a region 2 is that the smart lamp 1 and the smart lamp 2 execute a turning-on operation.

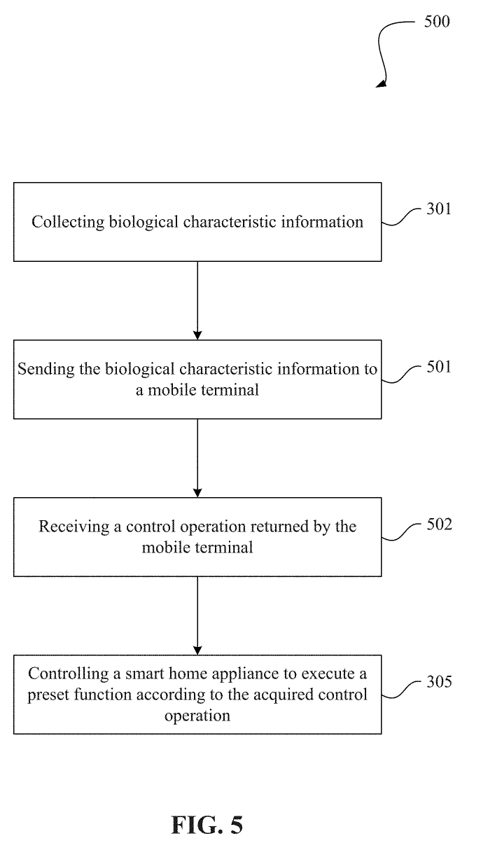

In the method 300 shown in FIG. 3, in Step 302 to Step 304, the control terminal acquires the relationship from the mobile terminal after acquiring the biological characteristic information, thereby obtaining the control operation corresponding to the biological characteristic information. In one embodiment, the control terminal may send the acquired biological characteristic information to the mobile terminal, and receives the control operation fed back by the mobile terminal. Therefore, Step 302 to Step 304 may be replaced with the following Step 501 and Step 502 of a method 500, as shown in FIG. 5.

In Step 501, the biological characteristic information is sent to the mobile terminal. The control terminal establishes the connection with the mobile terminal in the at least one manner of BT, WIFI and NFC. The control terminal sends the biological characteristic information to the mobile terminal in real time after collecting the biological characteristic information. After receiving the biological characteristic information, the mobile terminal acquires the control operation corresponding to the received biological characteristic information according to the relationship, pre-stored in the mobile terminal, between the biological characteristic information and the control operations. The mobile terminal feeds back the acquired control operation to the control terminal after acquiring the control operation.

When the smart appliance is a smart window, the control operation includes one of opening, closing and locking the smart window or regulating an opening angle of the smart window. When the smart appliance is a smart lamp, the control operation includes one of turning on, turning off or luminance regulation. When the smart appliance is a smart curtain, the control operation includes regulating an opening width or regulating an opening height. When the smart appliance is a smart air conditioner, the control operation includes one of turning on, turning off, temperature regulation, air volume regulation or timing.

In Step 502, the control operation returned by the mobile terminal is received. The control terminal receives the control operation corresponding to the biological characteristic information acquired by the mobile terminal according to the relationship .

In some embodiments, after collecting the biological characteristic information, the control terminal acquires the control operation corresponding to the collected biological characteristic information according to the relationship, pre-stored in the control terminal, between the biological characteristic information and the control operations. In some embodiments, after acquiring the control operation corresponding to the biological characteristic information, the control terminal stores the relationship between the biological characteristic information and the acquired control operation, so that the control terminal may control the smart home appliance to execute the preset function according to the control operation, stored previously, corresponding to the biological characteristic information after collecting the biological characteristic information again.

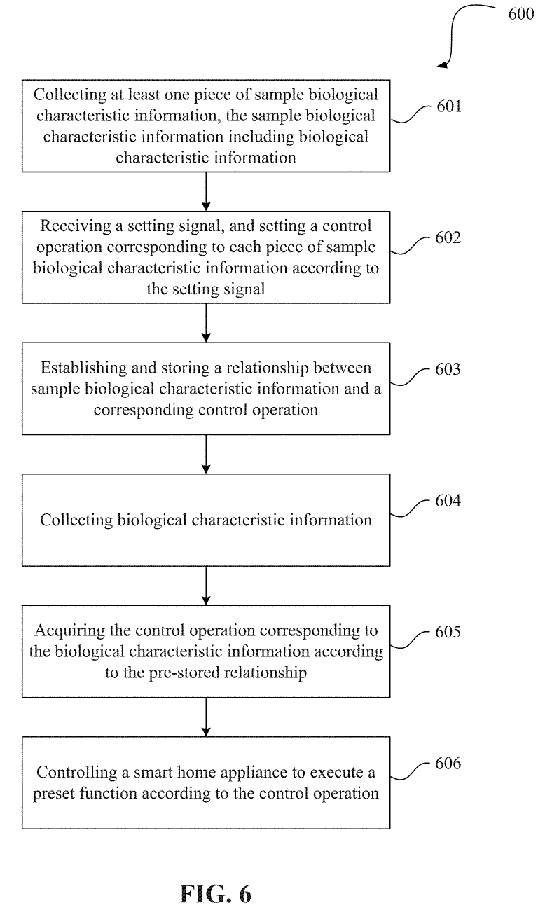

In some embodiments, a method 600 for controlling a device may include the following steps, as shown in FIG. 6.

In Step 601, at least one piece of sample biological characteristic information is collected. The sample biological characteristic information includes the biological characteristic information.

In one embodiment, the at least one piece of sample biological characteristic information includes: at least one piece of sample biological characteristic information of the same user, or, at least one piece of sample biological characteristic information of multiple users. For example, the control terminal collects fingerprint images of different fingers of the same user as sample fingerprint images. For another example, the control terminal acquires fingerprint images of different fingers of three users as sample fingerprint images.

In Step 602, a setting signal is received, and a control operation corresponding to each piece of sample biological characteristic information is set according to the setting signal.

The control terminal receives the setting signal triggered by the user after collecting the at least one piece of sample biological characteristic information. The setting signal refers to a signal of setting a corresponding control operation for each piece of sample biological characteristic information. The control terminal sets the control operation corresponding to each piece of sample biological characteristic information according to the setting signal after receiving the setting signal.

In Step 603, a relationship between sample biological characteristic information and a corresponding control operation is established and stored.

After the corresponding control operation is set for each piece of sample biological characteristic information, the relationship between the sample biological characteristic information and the corresponding control operation is established, and the relationship between each piece of sample biological characteristic information and the control operation is stored.

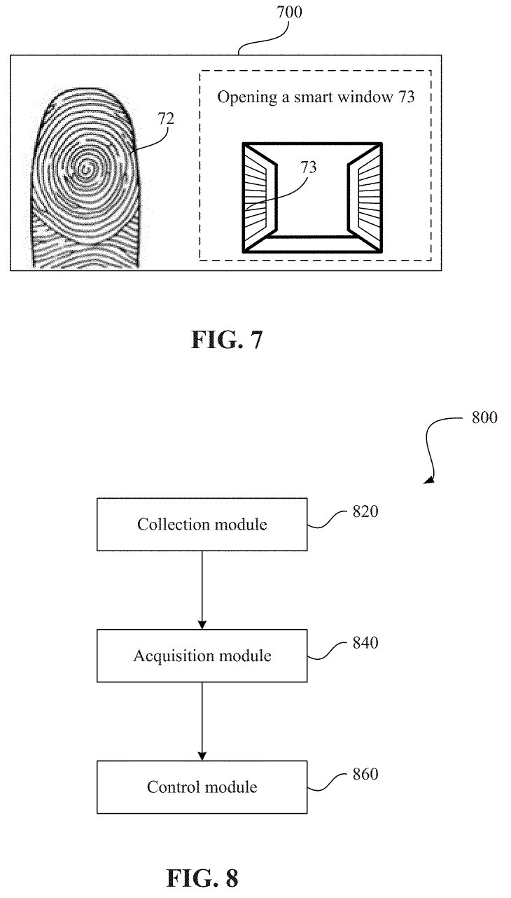

Step 601 to Step 603 are an exemplary implementation process of pre-storing the relationship in the control terminal, which is the same as the process of pre-storing the relationship in the mobile terminal shown in FIG. 3, and will not be described in detailed . In an exemplary example of the sample biological characteristic information being sample fingerprint images, a schematic diagram illustrating pre-storage of the relationship in the control terminal is shown in FIG. 7. Referring to FIG. 7, an interface for collecting and displaying the sample fingerprint images is set on a display interface of a control terminal 700. The control terminal 700 sets a corresponding control operation for each sample fingerprint image after collecting the sample fingerprint images. For example, the control operation corresponding to a sample fingerprint image 72 includes that: a smart window 73 executes an opening operation.

When a user is required to open a smart window, the smart home appliance may be controlled to execute the preset function only by inputting his own biological characteristic information, which may be performed in the following Step 604 to Step 606.

In Step 604, biological characteristic information is collected.

In Step 605, a control operation corresponding to the biological characteristic information is acquired according to the pre-stored relationship.

In Step 606, the smart home appliance is controlled to execute a preset function according to the control operation.

Step 604 is similar to Step 301 shown in FIG. 3, Step 606 is similar to Step 305 shown in FIG. 3, for which a detailed descriptions was provided above.

According to the above method, the biological characteristic information is collected; the control operation corresponding to the biological characteristic information is acquired; and the smart home appliance is controlled to execute the preset function according to the control operation. Therefore, problems associated with conventional technologies can be solved. Such problems may include, for example, a relatively more tedious control process and relatively higher complexity in an operation of the user since the user is required to control the smart home appliance to execute a fixed function through a fixed button when using the smart home appliance. Accordingly, controlling the smart home appliance to execute the preset function according to the control operation corresponding to the biological characteristic information of the user, can reduce complexity in control over the smart home appliance and simplify the control process.

In some embodiments, the smart home appliance executes the operation of the preset function in combination with a preset animation when the control terminal or the mobile terminal pre-stores the relationship between the biological characteristic information and the control operation. For example, the smart window executes the operation of opening the smart window in combination with a window opening animation. In one embodiment, the smart home appliance executes the operation of the preset function in combination with a preset voice. For example, the smart window A executes the operation of opening the smart window A in combination with a prompting voice of “open the smart window A”.

In some embodiments, the relationship between different control operations of the smart home appliance and different biological characteristic information is established. In one embodiment, when pre-storing the relationship between the biological characteristic information and the control operation, the control terminal or the mobile terminal may further store a control operation opposite to the control operation corresponding to biological characteristic information input last time when inputting the same biological characteristic information again. For example: the control operation corresponding to the fingerprint image 72 includes that: the smart window 73 executes the opening operation; and when the fingerprint image 72 is input again, the control terminal controls the smart window 73 to execute a closing operation.

In one embodiment, the control terminal or the mobile terminal sets the corresponding control operation for each piece of sample biological characteristic information according to the setting signal when collecting the at least one piece of sample biological characteristic information. In one embodiment, a plurality of control operations are pre-stored in the control terminal or the mobile terminal. When collecting the at least one piece of sample biological characteristic information, the control terminal or the mobile terminal selects a control operation required by each piece of sample biological characteristic information from the plurality of control operations, and stores the relationship between each piece of sample biological characteristic information and the selected control operation.

FIG. 8 is a block diagram of an apparatus 800 for controlling a device according to an exemplary embodiment. As shown in FIG. 8, the apparatus 800 may be applied to the control terminal shown in FIG. 1, and may include, but is not limited to: a collection module 820, an acquisition module 840, and a control module 860.

The collection module 820 is configured to collect biological characteristic information;

the acquisition module 840 is configured to acquire a control operation corresponding to the biological characteristic information, different biological characteristic information corresponding to different control operations; and the control module 860 is configured to control a smart home device to execute a preset function according to the control operation, the smart home device including at least one of a smart home appliance , a smart window and a smart curtain.

According to the apparatus 800, the biological characteristic information is collected; the control operation corresponding to the biological characteristic information is acquired; and the smart home appliance is controlled to execute the preset function according to the control operation. Therefore, problems associated with conventional technologies may be solved. Such problems may include, for example, a relatively more tedious control process and relatively higher complexity in operations of a user since the user is required to control the smart home appliance to execute a fixed function through a fixed button when using the smart home appliance. Accordingly, controlling the smart home appliance to execute the preset function according to the control operation corresponding to the biological characteristic information of the user, can reduce complexity in control over the smart home appliance and simplify the control process.

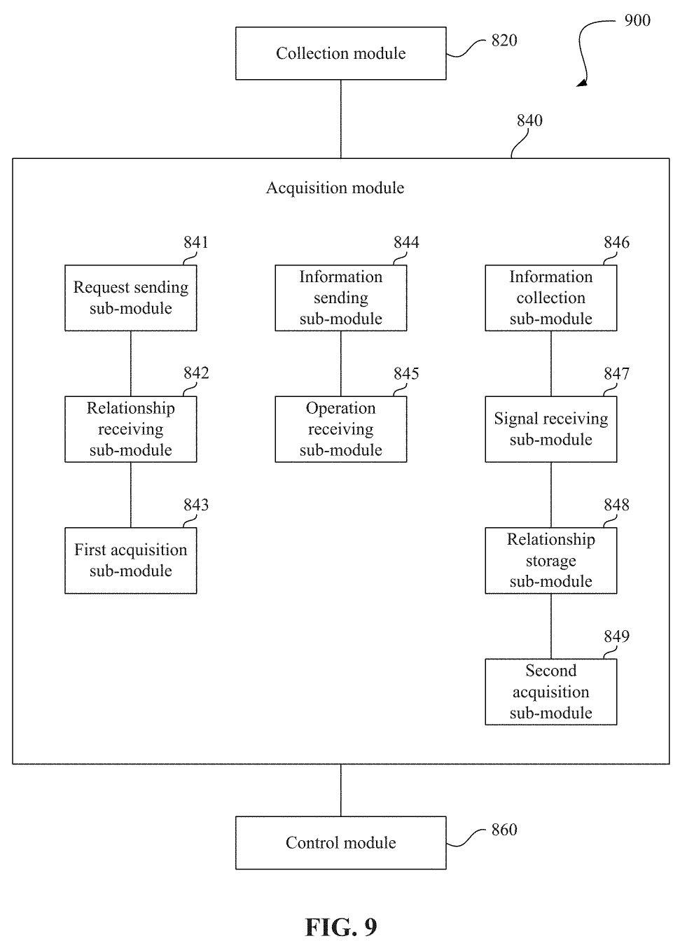

FIG. 9 is a block diagram of an apparatus 900 for controlling a device according to another exemplary embodiment. As shown in FIG. 9, the apparatus 900 may be applied to the control terminal shown in FIG. 1, and may include, but is not limited to: a collection module 820, configured to collect biological characteristic information; and

an acquisition module 840, configured to acquire a control operation corresponding to the biological characteristic information, different biological characteristic information corresponding to different control operations.

In one embodiment, the acquisition module 840 includes a request sending sub-module 841, a relationship receiving sub-module 842 and a first acquisition sub-module 843.

The request sending sub-module 841 is configured to send an acquisition request to a mobile terminal.

The relationship receiving sub-module 842 is configured to receive a relationship returned by the mobile terminal, the relationship including a relationship between biological characteristic information and control operations.

The first acquisition sub-module 843 is configured to acquire a control operation corresponding to the biological characteristic information according to the relationship.

In one embodiment, the acquisition module 840 includes an information sending sub-module 844 and an operation receiving sub-module 845.

The information sending sub-module 844 is configured to send the biological characteristic information to the mobile terminal, the mobile terminal acquiring the control operation corresponding to the biological characteristic information according to a relationship and the relationship including a relationship between biological characteristic information and control operations.

The operation receiving sub-module 845 is configured to receive the control operation returned by the mobile terminal.

In one embodiment, the acquisition module 840 includes an information collection sub-module 846, a signal receiving sub-module 847, a relationship storage sub-module 848 and a second acquisition sub-module 849.

The information collection sub-module 846 is configured to collect at least one piece of sample biological characteristic information, the sample biological characteristic information including the biological characteristic information.

The signal receiving sub-module 847 is configured to receive a setting signal and set a corresponding control operation for each piece of sample biological characteristic information according to the setting signal.

The relationship storage sub-module 848 is configured to establish and store a relationship between each piece of sample biological characteristic information and a corresponding control operation.

The second acquisition sub-module 849 is configured to acquire a control operation corresponding to the biological characteristic information according to the relationship.

The apparatus 900 may further include a control module 860. The control module 860 is configured to control a smart home device to execute a preset function according to the control operation, the smart home device including at least one of a smart home appliance, a smart window and a smart curtain.

In one embodiment, the smart home appliance includes a smart window. Accordingly, the control module 860 is further configured to control the smart window to be opened, closed and locked or regulate an opening angle of the smart window according to the control operation.

In one embodiment, the smart home appliance includes a smart lamp Accordingly, the control module 860 is further configured to control the smart lamp to be turned on and turned off or regulate luminance according to the control operation.

In one embodiment, the smart home appliance includes a smart air conditioner. Accordingly, the control module 860 is further configured to control the smart air conditioner to be turned on and turned off, regulate a temperature, regulate an air volume or implement timing according to the control operation.

In one embodiment, the smart home appliance includes a smart curtain. Accordingly, the control module 860 is further configured to control the smart curtain to regulate an opening width or regulate an opening height according to the control operation.

According to the apparatus 900, the biological characteristic information is collected; the control operation corresponding to the biological characteristic information is acquired; and the smart home appliance is controlled to execute the preset function according to the control operation. Therefore, problems associated with conventional technologies can be solved. Such problems may include, for example a relatively more tedious control process and relatively higher complexity in an operation of a user since the user is required to control the smart home appliance to execute a fixed function through a fixed button when using the smart home appliance. Accordingly, controlling the smart home appliance to execute the preset function according to the control operation corresponding to the biological characteristic information of the user, can reduce complexity in control over the smart home appliance and simplify the control process.

An exemplary embodiment of the present disclosure provides an apparatus for controlling a device, which may implement a method for controlling a device provided by the present disclosure. The apparatus includes a processor and a memory configured to store instructions executable by the processor.

The processor is configured to: collect biological characteristic information; acquire a control operation corresponding to the biological characteristic information; and control a smart home device to execute a preset function according to the control operation, the smart home device including at least one of a smart home appliance , a smart window and a smart curtain.

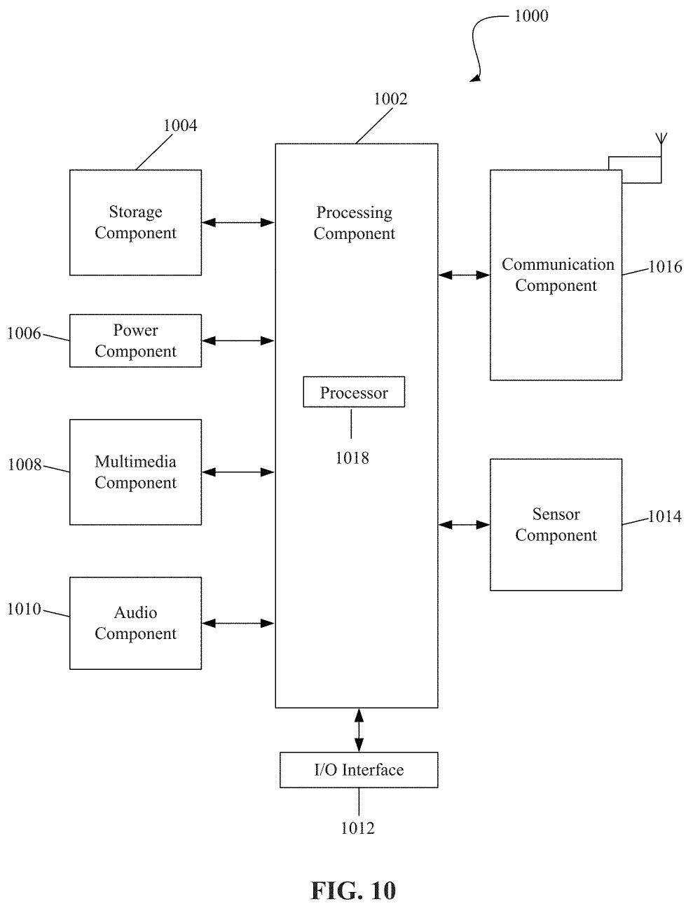

FIG. 10 is a block diagram of an apparatus 1000 for controlling a device according to an exemplary embodiment. For example, the apparatus 1000 may be a console, a mobile phone, a computer, a digital broadcast terminal, a messaging device, a gaming console, a tablet, a medical device, exercise equipment, a personal digital assistant or the like.

Referring to FIG. 10, the apparatus 1000 may include one or more of the following components: a processing component 1002, a storage component 1004, a power component 1006, a multimedia component 1008, an audio component 1010, an Input/Output (I/O) interface 1012, a sensor component 1014, and a communication component 1016.

The processing component 1002 typically controls overall operations of the apparatus 1000, such as the operations associated with display, telephone calls, data communications, camera operations, and recording operations. The processing component 1002 may include one or more processors 1018 to execute instructions to perform all or part of the steps in the abovementioned method. Moreover, the processing component 1002 may include one or more modules which facilitate interaction between the processing component 1002 and the other components. For instance, the processing component 1002 may include a multimedia module to facilitate interaction between the multimedia component 1008 and the processing component 1002.

The storage component 1004 is configured to store various types of data to support the operation of the apparatus 1000. Examples of such data include instructions for any APPs or methods operated on the apparatus 1000, contact data, phonebook data, messages, pictures, video, etc. The storage component 1004 may be implemented by any type of volatile or non-volatile memory apparatus, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1006 provides power for various components of the apparatus 1000. The power component 1006 may include a power management system, one or more power supplies, and other components associated with the generation, management and distribution of power for the apparatus 1000.

The multimedia component 1008 includes a screen providing an output interface between the apparatus 1000 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 1008 includes a front camera and/or a rear camera. The front camera and/or the rear camera may receive external multimedia data when the apparatus 1000 is in an operation mode, such as a photographing mode or a video mode. Each of the front camera and the rear camera may be a fixed optical lens system or have focusing and optical zooming capabilities.

The audio component 1010 is configured to output and/or input an audio signal. For example, the audio component 1010 includes a MIC, and the MIC is configured to receive an external audio signal when the apparatus 1000 is in the operation mode, such as a call mode, a recording mode and a voice recognition mode. The received audio signal may be further stored in the storage component 1004 or sent through the communication component 1016. In some embodiments, the audio component 1010 further includes a speaker configured to output the audio signal.

The I/O interface 1012 provides an interface between the processing component 1002 and a peripheral interface module, and the peripheral interface module may be a keyboard, a click wheel, a button or the like. The button may include, but not limited to: a home button, a volume button, a starting button and a locking button.

The sensor component 1014 includes one or more sensors configured to provide status assessment in various aspects for the apparatus 1000. For instance, the sensor component 1014 may detect an on/off status of the apparatus 1000 and relative positioning of components, such as a display and small keyboard of the apparatus 1000, and the sensor component 1014 may further detect a change in a position of the apparatus 1000 or a component of the apparatus 1000, presence or absence of contact between the user and the apparatus 1000, orientation or acceleration/deceleration of the apparatus 1000 and a change in temperature of the apparatus 1000. The sensor component 1014 may include a proximity sensor configured to detect presence of an object nearby without any physical contact. The sensor component 1014 may also include a light sensor, such as a Complementary Metal Oxide Semiconductor (CMOS) or Charge Coupled Device (CCD) image sensor, configured for use in an imaging APP. In some embodiments, the sensor component 1014 may also include an acceleration sensor, a gyroscope sensor, a magnetic sensor, a pressure sensor or a temperature sensor.

The communication component 1016 is configured to facilitate wired or wireless communication between the apparatus 1000 and another device. The apparatus 1000 may access a communication-standard-based wireless network, such as a WIFI network, a 2nd-Generation (2G), 3rd-Generation (3G), or 4th-Generation (4G) network or a combination thereof. In an exemplary embodiment, the communication component 1016 receives a broadcast signal from an external broadcast management system through a broadcast channel or broadcast associated information. In an exemplary embodiment, the communication component 1016 further includes an NFC module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In an exemplary embodiment, the apparatus 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute a method for controlling a device. The method includes: collecting biological characteristic information; acquiring a control operation corresponding to the biological characteristic information; and controlling smart home device to execute a preset function according to the control operation, the smart home device including at least one of a smart home appliance, a smart window and a smart curtain. In one embodiment, acquiring the control operation corresponding to the biological characteristic information includes: sending an acquisition request to a mobile terminal; receiving a relationship returned by the mobile terminal, the relationship including a relationship between biological characteristic information and control operations; and acquiring the control operation corresponding to the biological characteristic information according to the relationship. In one embodiment, acquiring the control operation corresponding to the biological characteristic information includes: sending the biological characteristic information to the mobile terminal, the mobile terminal acquiring the control operation corresponding to the biological characteristic information according to a relationship and the relationship including a relationship between biological characteristic information and control operations; and receiving the control operation returned by the mobile terminal. In one embodiment, acquiring the control operation corresponding to the biological characteristic information includes: collecting at least one piece of sample biological characteristic information, the sample biological characteristic information including the biological characteristic information; receiving a setting signal, and setting a corresponding control operation for each piece of sample biological characteristic information according to the setting signal; establishing and storing a relationship between each piece of sample biological characteristic information and a corresponding control operation; and acquiring the control operation corresponding to the biological characteristic information according to the relationship. In one embodiment, the smart home appliance includes a smart window, and controlling the smart home appliance to execute the preset function according to the control operation includes: controlling the smart window to be opened, closed and locked or regulating an opening angle of the smart window according to the control operation. In one embodiment, the smart home appliance includes a smart lamp, and controlling the smart home appliance to execute the preset function according to the control operation includes: controlling the smart lamp to be turned on and turned off or regulating luminance according to the control operation. In one embodiment, the smart home appliance includes a smart air conditioner, and controlling the smart home appliance to execute the preset function according to the control operation includes: controlling the smart air conditioner to be turned on and turned off, regulating a temperature or an air volume or implementing timing according to the control operation. In one embodiment, the smart home appliance includes a smart curtain, and controlling the smart home appliance to execute the preset function according to the control operation includes: regulating an opening width an opening height of the smart curtain according to the control operation.

In an exemplary embodiment, there is also provided a non-transitory computer-readable storage medium including instructions, such as the storage component 1004 including instructions. The instructions may be executed by the processor 1018 of the apparatus 1000 to implement the abovementioned method. For example, the non-transitory computer-readable storage medium may be a ROM, a Radom Access Memory (RAM), a Compact Disc Read-Only Memory (CD-ROM), a magnetic tape, a floppy disc, an optical data storage device or the like.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for controlling a device, comprising:
collecting biological characteristic information;
acquiring a control operation corresponding to the biological characteristic information, different biological characteristic information corresponding to different control operations; and
controlling the device to execute a preset function according to the acquired control operation.

2. The method of claim 1, wherein acquiring the control operation corresponding to the biological characteristic information comprises:
sending an acquisition request to a mobile terminal;
receiving a relationship from the mobile terminal, the relationship being a relationship between prestored biological characteristic information and control operations; and
acquiring the control operation corresponding to the biological characteristic information according to the relationship.

3. The method of claim 1, wherein acquiring the control operation corresponding to the biological characteristic information comprises:
sending the biological characteristic information to a mobile terminal, the mobile terminal acquiring the control operation corresponding to the biological characteristic information according to a relationship and the relationship being a relationship between prestored biological characteristic information and control operations; and
receiving the control operation returned by the mobile terminal.

4. The method of claim 1, wherein acquiring the control operation corresponding to the biological characteristic information comprises:
collecting at least one piece of sample biological characteristic information, the sample biological characteristic information including the biological characteristic information;
receiving a setting signal, and setting a corresponding control operation for each piece of sample biological characteristic information according to the setting signal;
establishing and storing a relationship between each piece of sample biological characteristic information and the corresponding control operation; and
acquiring the control operation corresponding to the biological characteristic information according to the relationship.

5. The method of claim 1, wherein the device comprises a smart window, and controlling the device to execute the preset function according to the acquired control operation comprises:
controlling the smart window to be opened, closed and locked, or regulate an opening angle of the smart window according to the control operation.

6. The method of claim 1, wherein the device comprises a smart lamp, and controlling the device to execute the preset function according to the acquired control operation comprises:
controlling the smart lamp to be turned on and turned off, or regulating luminance according to the control operation.

7. The method of claim 1, wherein the device comprises a smart air conditioner, and controlling the device to execute the preset function according to the acquired control operation comprises:
controlling the smart air conditioner to be turned on and turned off, regulating a temperature or an air volume, or implementing timing according to the control operation.

8. The method of claim 1, wherein the device comprises a smart curtain, and controlling the device to execute the preset function according to the acquired control operation comprises:
regulating an opening width or an opening height of the smart curtain according to the control operation.

9. An apparatus for controlling a device, comprising:
a processor; and
a memory configured to store instructions executable by the processor,
wherein the processor is configured to:
collect biological characteristic information;
acquire a control operation corresponding to the biological characteristic information, different biological characteristic information corresponding to different control operations; and
control the device to execute a preset function according to the acquired control operation.

10. The apparatus of claim 9, wherein the processor is further configured to:
send an acquisition request to a mobile terminal;
receive a relationship returned by the mobile terminal, the relationship being a relationship between prestored biological characteristic information and control operations; and
acquire the control operation corresponding to the biological characteristic information according to the relationship.

11. The apparatus of claim 9, wherein the processor is further configured to:
send the biological characteristic information to a mobile terminal, the mobile terminal acquiring the control operation corresponding to the biological characteristic information according to a relationship, the relationship being a relationship between prestored biological characteristic information and control operations; and
receive the control operation returned by the mobile terminal.

12. The apparatus of claim 9, wherein the processor is further configured to:
collect at least one piece of sample biological characteristic information, the sample biological characteristic information comprising the biological characteristic information;
receive a setting signal and set a corresponding control operation for each piece of sample biological characteristic information according to the setting signal;
establish and store a relationship between each piece of sample biological characteristic information and the corresponding control operation; and
acquire the control operation corresponding to the biological characteristic information according to the relationship.

13. The apparatus of claim 9, wherein the device comprises a smart window, and the processor is further configured to control the smart window to be opened, closed and locked, or regulate an opening angle of the smart window according to the acquired control operation.

14. The apparatus of claim 9, wherein the device comprises a smart lamp, and the processor is further configured to control the smart lamp to be turned on and turned off, or regulate luminance according to the acquired control operation.

15. The apparatus of claim 9, wherein the device comprises a smart air conditioner, and the processor is further configured to control the smart air conditioner to be turned on and turned off, regulate a temperature or an air volume, or implement timing according to the acquired control operation.

16. The apparatus of claim 9, wherein the device comprises a smart curtain, and the processor is further configured to regulate an opening width or an opening height of the smart curtain according to the acquired control operation.

17. A non-transitory computer-readable storage medium having stored therein instructions that, when executed by a processor, causes the processor to perform a method for controlling a device, the method comprising:
collecting biological characteristic information;
acquiring a control operation corresponding to the biological characteristic information, different biological characteristic information corresponding to different control operations; and
controlling the device to execute a preset function according to the acquired control operation.
